(19) United States
(12) Patent Application Publication
(10) Pub. No.: US 2002/0055370 A1
(43) Pub. Date: May 9, 2002

(54) Wireless transmission apparatus

(76) Inventor: Hsien-Kai Chen, Chung-Ho City (TW)

Correspondence Address: Ladas & Parry, 26 West 61st Street, New York, NY, 10023, US

(21) Appl. No.: 10/000,940

(22) Filed: Nov. 2, 2001

(30) Foreign Application Priority Data
Nov. 6, 2000 (TW) 89219246

(51) Int. Cl. H04M 1/00

(52) U.S. Cl. 455/557; 455/524

(57) ABSTRACT

A wireless transmission apparatus comprising a transceiving base and a portable transceiving apparatus is disclosed. One end of the transmission base connects to a socket of a client end of the public switched telephone network (PSTN), and the transmission base can transmits/receives signals to/from the portable transceiving apparatus at radio frequencies. Another end of the portable transceiving apparatus has at least one socket to which at least one conventional communication device is connected via a first cable. By way of connection described above, the at least one communication device can perform a remote signal transmission through a transmission path from the portable transceiving apparatus and the transmission base to the PSTN. Moreover, the portable transceiving apparatus can be further incorporated into the communication device to facilitate the usage.

### BACKGROUND OF THE INVENTION

1. Field of the Invention

The present invention relates to a wireless transmission apparatus, and in particular, to a wireless transmission apparatus that can transmit signals to a remote end through the public switched telephone network (PSTN).

2. Description of the Prior Art

Conventional techniques for remote signal transmission, such as transmissions by phone, fax, Internet, E-mail, and etc., are conducted by connecting information devices (through external or internal modems) or communication devices to sockets of client ends of the PSTN by cable in advance , then these devices function normally; and the PSTN may be a conventional teleconurnunication system or a data transmission system. Because there are a large number of information and communication devices in offices or homes, cables and wires of these devices are often disordered and difficult to arrange. Moreover, since the connecting sockets of the PSTN in offices or homes are usually located at certain positions; it is difficult to have the information or communication devices located at where users can conveniently use them, thus conventional remote signal transmission is not considered convenient.

FIG. 1 is a schematic diagram of a conventional scheme which connects several information devices to a socket of a client end by cable. As shown in FIG. 1, one end of a router (or a hub) 20 is connected to a socket of the PSTN via a second cable 112, and the other end of the router has a plurality of sockets 201 to which several information devices, such as notebook personal computers 15 and personal computers 19, are connected via first cables 111. In this way, the several information devices can perform remote signal transmission simultaneously. As mentioned above, the connecting scheme shown in FIG. 1 inevitably disorders the cables and thus makes the cables difficultly to be arranged. Furthermore, if there is no router 20 used for interconnecting the PSTN and the information devices, each information or communication device needs to connect to a socket of the PSTN separately, rendering the arrangement of the cables even more difficult. And due to the limited locations of the sockets of the PSTN, it is also difficult to have the devices located at where the users intend to located them.

A solution to the problem of the above cable connection is the use of wireless transmission technologies, such as infrared data transmission and bluetooth. For an infrared data transmission, an infrared transmission port of two signal transmission devices has to be in alignment with each other without any objects placed therebetween. Due to strict limitations for conducting an infrared data transmission, it is obviously not convenient to use and gradually loses its attractiveness to public. As for bluetooth, it uses a frequency as high as 2.4 GHz to transmit signal, so there is no direction and obstacle limitations as infrared data transmission has; but cost for conducting bluetooth is about 8 to 10 times higher compare to wire transmission, and its radio frequency range is too short for just 10 meters.

Furthermore, both bluetooth and infrared data transmission are limited by their specific transmission protocols. Thus users have to increase their budge for purchasing peripheral hardware; moreover, the two methods are just suitable for information devices that mainly transmit digital data, but hard to apply on communication devices. Because of all the shortcomings, the conventional wireless transmission technologies still cannot fully meet the needs of current users.

### SUMMARY OF THE INVENTION

The object of the present invention is to provide a wireless transmission apparatus that combines the PSTN with the wireless transmission technology to perform remote signal transmission.

A second object of the present invention is to provide a cost effectively wireless transmission apparatus in which the use of the cables is significantly reduced.

A third object of the present invention is to provide a wireless transmission apparatus that enables users to perform remote signal transmission by a wireless transmission method as soon as possible.

Yet another object of the present invention is to provide a wireless transmission apparatus, which enables users to perform remote signal transmission everywhere as long as they consider the place is convenient for them.

To achieve the above-mentioned objects, the wireless transmission apparatus of the present invention comprises:

a transceiving base, which can emit and receive signal; one end of the transmission base connects to a socket of the client end of PSTN via a second cable; and

at least one portable transceiving apparatus, which can communicate with the transmission base by a habitual used radio frequency; one end of it has sockets, such as conventional telephone line sockets, for connecting to general communication and information devices, such as telephone, fax machine, notebook, personal digital assistant (PDA), and so on., via first cables separately.

In other word, the communication and information devices conduct remote signal transmission through the combination of a first cable, a portable transceiving apparatus, a transmission base, a second cable, and PSTN.

The portable transceiving apparatus can also be embedded in the communication or information devices, thus users no longer need to take the portable transceiving apparatus and the first cable along with them. For managing cables in offices or homes, it can further reduce the amount of cables thus easier to arrange.

### BRIEF DESCRIPTION OF THE DRAWINGS

The present invention will be more explained according to the accompanying drawings, in which:

FIG. 1 is a schematic diagram showing a conventional scheme for connecting several information devices to a socket of a client end;

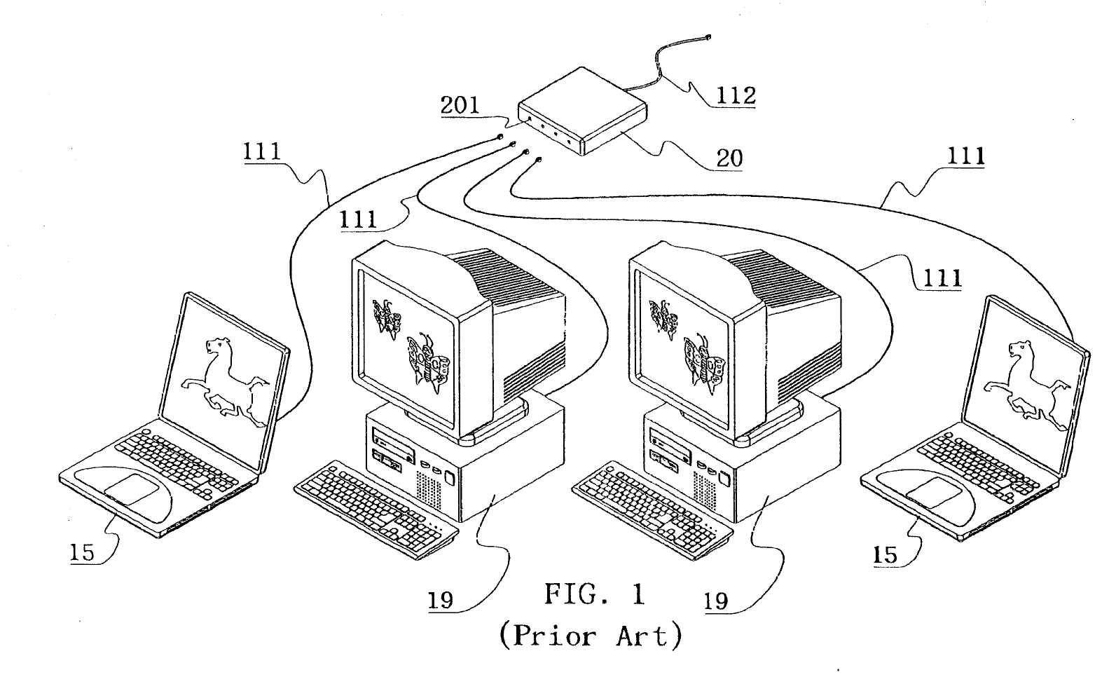

FIG. 2 is a first embodiment of the wireless transmission apparatus according to the present invention; and

FIG. 3 is a second embodiment of the wireless transmission apparatus according to the present invention.

### DETAILED DESCRIPTION OF THE PREFERRED EMBODIMENT

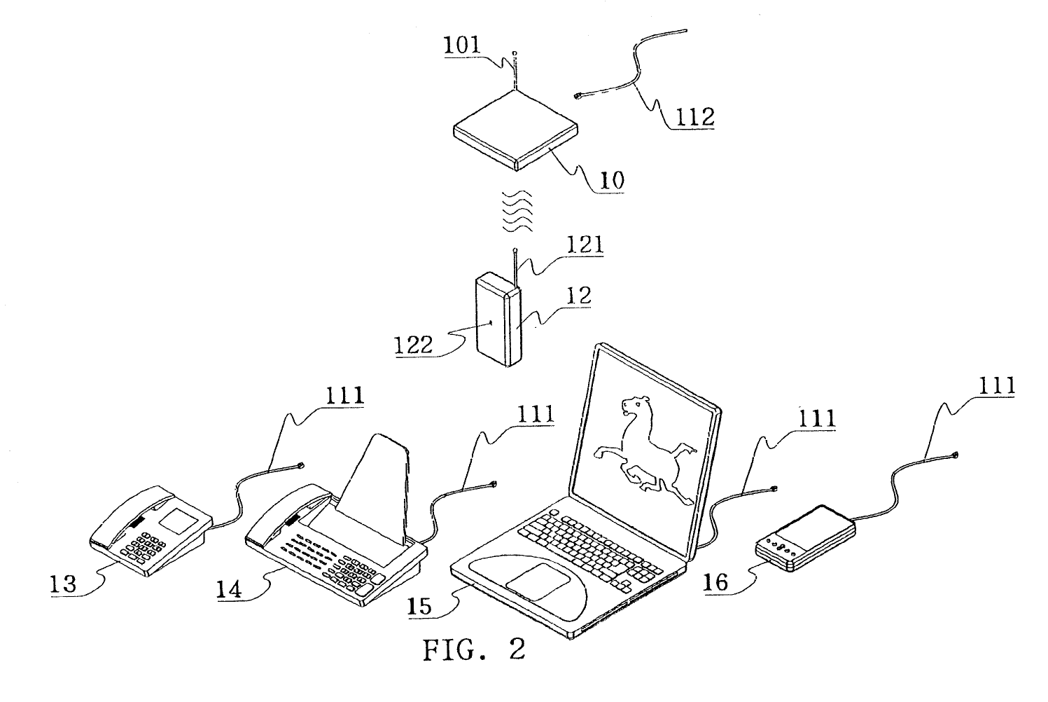

FIG. 2 is the first embodiment of the wireless transmission apparatus according to the present invention. As shown in FIG. 2, a transceiving base 10 has a first antenna 101, and one end of the transceiving base 10 connects to a socket of a client end of the PSTN via a second cable 112 and thus conducts a remote signal transmission by the PSTN. The first antenna 101 of the transceiving base 10 receives signals from a portable transceiving apparatus 12 at conventional radio frequencies; the transceiving base 10 then converts the received signals in a predetermined format and conducts a remote signal transmission via the second cable 112. On the other hand, the transceiving base 10 can also receive remote signals via the second cable 112. After the received signals are converted, the first antenna 101 of the transceiving base 10 then transmits the converted signals to the portable transceiving apparatus 12 at conventional radio frequencies. The portable transceiving apparatus 12 has a second antenna 121 and at least one socket 122, such as a conventional socket for telephone line, wherein the second antenna 121 can transmit signals to the first antenna 101 of the transceiving base 10 at conventional radio frequencies; and the socket 122 can connect to conventional communication or information devices, such as telephone 13, fax machine 14, notebook PC 15, PDA 16, and etc., via first cables 111. In other words, the communication or information devices conduct remote signal transmission through the first cable 111, the portable transceivihg apparatus 12, the transceiving base 10, the second cable 112, and the PSTN.

Since the communication or information devices connect to the portable transceiving apparatus 12 through shorter first cables than the conventional connecting scheme, and thus overcomes the shortcoming of the conventional signal transmission scheme, in which cables are messy and hard to be managed. The portable transceiving apparatus 12 of the present invention can be set at any suitable locations, and thus overcomes the shortcoming of the conventional signal transmission scheme that the locations of communication or information devices are not easily arranged. The transceiving base 10 and the portable transceiving apparatus 12 transmit signals to each other at conventional radio frequencies, so the present invention does not have the limitations of the conventional infrared data transmission that the transmission is directional and there should be no obstacle in the transmission path. Moreover, since the radio frequencies used in the present invention are public frequencies, it is needless to apply use permission in advance or use a specific protocol for the frequencies, and the price of the wireless transmission module for the radio frequency is very cheap due to commercialize on large scale, so the limitations of bluetooth can be overcome as well.

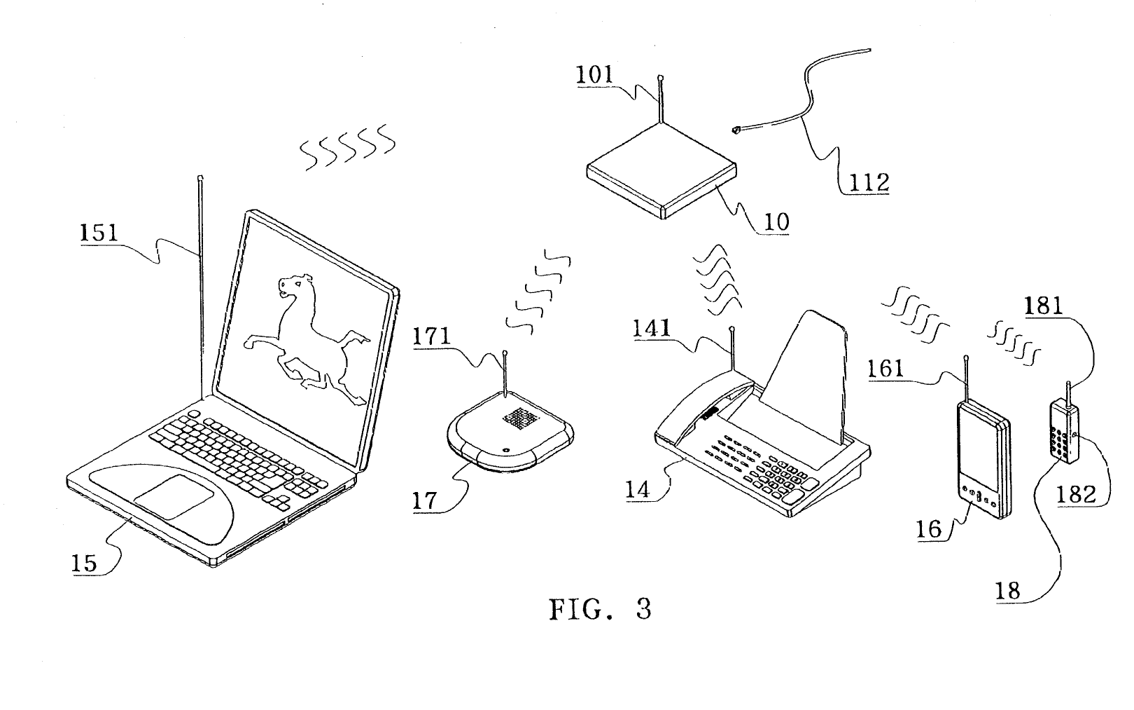

FIG. 3 is a schematic diagram of the second embodiment of the wireless transmission apparatus according to the present invention. In FIG. 3 the portable transceiving apparatus 12 is incorporated into the communication and information devices. In other words, all communication and information devices, such as fax machine 14, wireless telephone 18, notebook PC 15, PDA 16, and modem 17, have third antennas 141, 181, 151, 161, and 171, respectively, and a wireless signal modulation/demodulation module (not shown in the Figure). The third antennas 141, 151, 161, 171, and 181 can transmit signal with the first antenna 101 of the transceiving base 10 at radio frequencies; the modulation/demodulation module modulates the signals from the communication and information devices and demodulates the signals sent to the communication and information devices. With the portable transceiving apparatus being incorporated into the communication and information devices, it is no longer necessary for a user to carry an extra portable transceiving apparatus 12 and a first cable 111 and to regulate the cables, it can also reduce the quantity of cable thus make it easier to manage.

It is also shown in FIG. 3 that the portable transceiving apparatus 12 can be obtained by modifying a conventional wireless telephone 18. At one side of the wireless telephone 18, there is a telephone line socket 182 to which other communication or information devices can be connected by the first cable 111 for signal transmission.

The technical contents and features of the present invention have been disclosed above. The protection scope of the present invention shall not be limited to what is disclosed in the embodiments. Persons skilled in the art may modify or change the present invention based on the disclosure thereof without departing from the spirit of the present invention covered by the claims a appended below.

What is claimed is:

1. A wireless transmission apparatus for providing a remote signal transmission over a communication network comprising:
a transceiving base having a first antenna and connecting at its one end to a socket of a client end of the communication network via a second cable; and
at least one portable transceiving apparatus, each comprising a second antenna and at least one socket, wherein the portable transceiving apparatus transmits/receives signals via the second antenna to/from the transmission base, and the socket connects to the communication or information device via a first cable;
thereby the at least one communication or information device performing a remote signal transmission over a transmission path from the portable transceiving apparatus and the transceiving base to the communication network.

2. The apparatus according to claim 1, wherein the socket of the at least one portable transceiving apparatus is a telephone line socket.

3. The apparatus according to claim 1, wherein the at least one portable transceiving apparatus is a wireless phone.

4. The apparatus according to claim 2, wherein the at least one communication device is one of a telephone and a fax machine.

5. The apparatus according to claim 1, wherein the at least one communication device is one of a notebook personal computer, a PDA, and a modem.

6. A wireless transmission apparatus for providing a remote signal transmission over a communication network, comprising:
a transceiving base, having a first antenna and connecting at its one end to a socket of a client end of the communication network via a second cable; and
at least one communication device, comprising a third antenna and a modulation/demodulation module, wherein the third antenna can transmit signal with the first antenna of the transceiving base at radio frequencies, and the modulation/demodulation module modulates the signals emitted from the at least one communication device and demodulates the signals received by the at least one communication devices;
thereby the at least one communication or information device performing a remote signal transmission over a transmission path from the portable transceiving apparatus and the transmission base to the communication network.

7. The apparatus according to claim 6, wherein the at least one communication device is one of a telephone and a fax machine.

8. The apparatus according to claim 6, wherein the at least one information device is one of a notebook personal computer, a PDA, and a modem.
